(19) United States
(12) Patent Application Publication
(10) Pub. No.: US 2009/0018706 A1
(43) Pub. Date: Jan. 15, 2009

(54) FLEXIBLE ELECTRIC LOAD MANAGEMENT SYSTEM AND METHOD THEREFORE

(76) Inventor: Lupu Wittner, Netanya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/092,821

(22) PCT Filed: Nov. 26, 2006
(86) PCT No.: PCT/IL06/01360

§ 371 Date: Aug. 18, 2008

Related U.S. Application Data
(60) Provisional application No. 60/739,355, filed on Nov. 25, 2005.

(51) Int. Cl. G06F 1/32; G06F 1/26; G06N 5/02

(52) U.S. Cl. 700/295; 706/47

(57) ABSTRACT

A system for controlling electricity consumption of an electricity consumer having a plurality of loads, including: (a) a main central processing unit, connected to a power source, and adapted to receive a signal therefrom; (b) a memory associated with the processing unit; (c) controlled relay assemblies connected to a plurality of loads via local circuit breakers, each assembly including: (i) a relay, responsive to the processing unit; (ii) a current sensor, electrically connected to the relay, the relay and the current sensor being electrically associated with the processing unit, and (iii) an electrical line having a first end connecting the relay assembly to the power source, and having a second end connecting to a local circuit breaker connected to at least one load; wherein each current sensor is adapted to provide, to the processing unit, data pertaining to current drawn via a particular local circuit breaker, and wherein the processing unit is configured to command the relay based on the signal received from the power source, and based on a set of rules provided to the processing unit, the set of rules including load priority information, such that each relay opens or closes in response to the command from the processing unit, so as to shut off or restore power to the electrical line.

### FIELD AND BACKGROUND OF THE INVENTION

The present invention relates to a computerized system for monitoring and controlling electricity consumption, and, more particularly, to a flexible system and method for electric power management.

It is known that many electric utilities around the world suffer from lack of electricity at peak demand hours. Historically, demand for power increases each year, especially during peak heating and cooling months, resulting in a need for ever-increasing amounts of generation capacity. The deregulation of the electric industry has heightened concerns over power outages, price volatility and how the eventual outcome will impact the economy and our way of life. Demand reduction programs and more advanced controls have been proposed to assist in reducing demand during peak times.

Electric utilities have been expanding demand-side management (DSM) programs to promote energy efficiency, reduce toxic air emissions, and achieve cost effectiveness for both utilities and consumers, mainly by deferring the need to build new power plants. These programs include planning, implementing, and monitoring activities of electric utilities that are designed to encourage consumers to modify their levels and patterns of electricity consumption. These activities are performed to benefit utilities, consumers, and society.

One objective of DSM is to achieve peak load reductions. Utilities offer demand reduction programs to their customers to shift loads out of peak periods by providing a financial incentive for consumers to move loads to a time when it is less expensive for the utility to produce or obtain power. Direct load control or load shedding programs offer the customer a monthly credit for allowing the utility to interrupt power to individual appliances or other loads in their home during peaks or emergencies. The customer decides in advance, together with the utility company, which appliances will be disconnected at peak demand hour.

Typically, the utility company installs a switch in series with those appliances and, when demand exceeds a pre-determined level, the utility company transmits a command to the switch to disconnect one or more of the appliances. For example, a domestic consumer may authorize the utility to interrupt service to a home air conditioning unit during the hours of peak load. But in the middle of a heat wave, the consumer may find himself with an air-conditioning unit that he wishes to operate, but cannot. When the impact of load shedding on customer comfort becomes apparent, many customers opt to leave the program.

Another disadvantage of such systems is that customers are often paid for participating in such a program, whether or not the utility actually implements the cutoff. The amount paid does not necessarily correspond with the load reduction. Another ramification of this load-shedding approach is that the utility, in transmitting a command to cut off power to an appliance, does not know if a power reduction will indeed be realized.

U.S. Pat. No. 6,772,052 and U.S. Pat. No. 7,130,719 disclose electronic systems for controlling power consumption at a consumer of electric power. The systems include a main controlling unit and one or more nodes, each respective node having a local microprocessor or control unit, close in proximity to the load being controlled thereby. When the main controller receives a signal from the electric company, this local unit turns off or adjusts power at the proximate node, according to preset instructions that take into account the comfort level of the customer.

However, such systems are highly involved, costly and correspondingly inconvenient to install and maintain. The systems may include a large plurality of microprocessors, according to the number of loads being controlled, and the resulting inter-microprocessor communication is complicated. In addition, each node is installed separately, resulting in the system being sprawled around the premises of the consumer.

A node may be installed within the load, but tampering with the electronics in the load is involved and may invalidate warrantees on the load. A node not contained within the load itself, is exposed to possible unintentional damage and to the environment. Furthermore, in an already constructed residential building, such nodes tend to be visible, creating an eyesore that the consumer would have reason to conceal. As a result of the cost and inconvenience, such systems appear to be largely impractical.

There is therefore a recognized need for a simplified, low cost system and method that reduces energy consumption during electric peak demand hours, without affecting customer comfort. It would be highly advantageous for such a system to be easily installable and maintainable, and largely removed from environmental exposure and potential damage. It would be of further advantage for the system to be flexible so that the consumer can adjust the conditions and prioritize the order of the load shedding according to his current needs without having to contact the electric utility.

### SUMMARY OF THE INVENTION

According to the teachings of the present invention there is provided a computerized load management system for monitoring and controlling electricity consumption of an electricity consumer having a plurality of loads, the system including: (a) a main central processing unit, connected to a power source, and adapted to receive a signal therefrom; (b) a memory associated with the main central processing unit; (c) a plurality of controlled relay assemblies connected to a plurality of loads via a plurality of local circuit breakers, each assembly of the assemblies including: (i) a relay, responsive to the main central processing unit; (ii) a current sensor, electrically connected to the relay, the relay and the current sensor being electrically associated with the main central processing unit, and (iii) an electrical line having a first end connecting the relay assembly to the power source, and having a second end connecting to a local circuit breaker connected to at least one load; wherein each current sensor is adapted to provide, to the main central processing unit, data pertaining to current drawn via a particular local circuit breaker of the local circuit breakers, and wherein the main central processing unit is configured to command the relay based on the signal received from the power source, and based on a set of rules provided to the main central processing unit, the set of rules including load priority information, such that each relay opens or closes in response to the command from the main central processing unit, so as to shut off power or restore power to a particular electrical line.

According to another aspect of the present invention there is provided a computerized load management system for monitoring and controlling electricity consumption of an electricity consumer having a plurality of loads, the system including: (a) a main central processing unit, adapted for connecting to a power source, and adapted to receive a signal therefrom; (b) a memory associated with the main central processing unit; (c) a plurality of controlled relay assemblies for connecting to a plurality of loads via a plurality of local circuit breakers, each assembly including: (i) a relay, responsive to the main central processing unit; (ii) a current sensor, electrically connected to the relay, the relay and the current sensor being electrically associated with the main central processing unit, and (iii) an electrical line having a first end adapted for connecting the relay and the current sensor to the power source, and having a second end adapted for connecting to a local circuit breaker connected to at least one load, wherein, when the load management system is connected to the power source and to the loads, each current sensor is adapted to provide, to the main central processing unit, data pertaining to current drawn via a particular local circuit breaker of the local circuit breakers, and wherein the main central processing unit is configured to command a relay based on the signal received from the power source, and based on a set of rules provided to the main central processing unit, the set of rules including load priority information, such that each relay opens or closes in response to a command from the main central processing unit, so as to shut off power or restore power to a particular electrical line, and wherein the relay assemblies are directly responsive to the main central processing unit.

According to yet another aspect of the present invention there is provided a computerized load management system for monitoring and controlling electricity consumption of an electricity consumer having a plurality of loads, the system including: (a) a main central processing unit, adapted for connecting to a power source, and adapted to receive a signal therefrom; (b) a memory associated with the main central processing unit; (c) a plurality of controlled relay assemblies for connecting to a plurality of loads via a plurality of local circuit breakers, each assembly including: (i) a relay, responsive to the main central processing unit; (ii) a current sensor, electrically connected to the relay, the relay and the current sensor being electrically associated with the main central processing unit, and (iii) an electrical line having a first end adapted for connecting the relay and the current sensor to the power source, and having a second end adapted for connecting to a local circuit breaker connected to at least one load, wherein, when the load management system is connected to the power source and to the loads, each current sensor is adapted to provide, to the main central processing unit, data pertaining to current drawn via a particular local circuit breaker of the local circuit breakers, and wherein the main central processing unit is configured to command a relay based on the signal received from the power source, and based on a set of rules provided to the main central processing unit, the set of rules including load priority information, provided by the electricity consumer, such that each relay opens or closes in response to a command from the main central processing unit, so as to shut off power or restore power to a particular electrical line.

According to further features in the described preferred embodiments, the computerized load management system is entirely disposed between a main circuit breaker connected to the power source, and the local circuit breakers.

According to still further features in the described preferred embodiments, the main central processing unit, the memory and the relay assemblies are enclosed within a single housing.

According to still further features in the described preferred embodiments, the main central processing unit is adapted to send, to the power source, information pertaining to power consumption.

According to still further features in the described preferred embodiments, the information is based on the data provided by each current sensor.

According to still further features in the described preferred embodiments, the information pertaining to power saved during load management.

According to still further features in the described preferred embodiments, the main central processing unit is configured to display load priority information for closing and opening the relay assemblies.

According to still further features in the described preferred embodiments, the main central processing unit is configured to receive, from a user, input associated with priorities and conditions for closing and opening the relays.

According to still further features in the described preferred embodiments, the load management system further includes: (d) a current sensor, associated with the power source and the central processing unit, for measuring total current, as a function of time, being drawn by the loads, and for providing data pertaining to the current to the central processing unit.

According to still further features in the described preferred embodiments, the main central processing unit is configured to command each relay to close and open so that a total power consumption consumed by the plurality of loads is held beneath a power consumption threshold.

According to still further features in the described preferred embodiments, the main central processing unit controls an order of opening and closing of the relays based on rules preprogrammed into the main central processing unit, the rules including: (I) the main central processing unit closes at least a first relay, so as to cut off power to at least one of the loads, according to a lowest priority of the consumer.

According to still further features in the described preferred embodiments, prior to (I) the main central processing unit determines, based on historical data on current drawn through the first relay, that the cut off of the power will reduce the total power consumption below the power consumption threshold.

According to still further features in the described preferred embodiments, the rules further include: (II) the main central processing unit checks, in a substantially continuous manner, power consumption on each electric line, and when a drop in the total power consumption is observed, the main central processing unit determines that at least one particular relay can be opened, without exceeding the power consumption threshold, and subsequently commands the particular relay to open, so as to restore power via the particular relay.

According to still further features in the described preferred embodiments, the rules further include: (III) after at least one relay is opened, the main central processing unit checks that the total power consumption is still beneath the power consumption threshold.

According to still further features in the described preferred embodiments, the rules further include: (IV) if the main central processing unit determines that the total power consumption exceeds the threshold, the main central processing unit closes a lowest priority relay unit.

According to still further features in the described preferred embodiments, the rules further include: (V) after waiting for a predetermined time, the main central processing unit retries opening the lowest priority relay unit.

According to still further features in the described preferred embodiments, solely the main central processing unit is disposed between the power source and the loads.

According to still further features in the described preferred embodiments, the relay assemblies are directly responsive to the main central processing unit.

According to still further features in the described preferred embodiments, at least one of the relay assemblies is connected to, or adapted for, at least two appliances.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of a preferred embodiment of the flexible electric load management system according to the present invention, and FIG. 2 is an exemplary graph of power consumption over time at the premises of a consumer, showing the load management of the inventive system under varying electric loads and conditions.

### DESCRIPTION OF THE PREFERRED EMBODIMENTS

One aspect of the present invention is a flexible, centralized electric load management system. The principles and operation of this flexible, centralized electric load management system according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

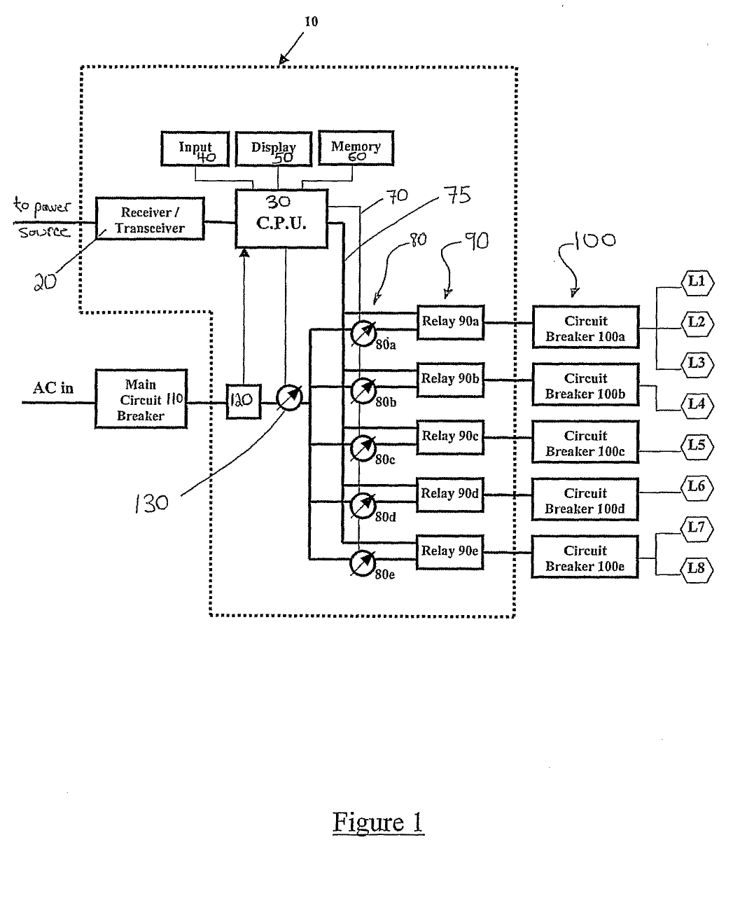

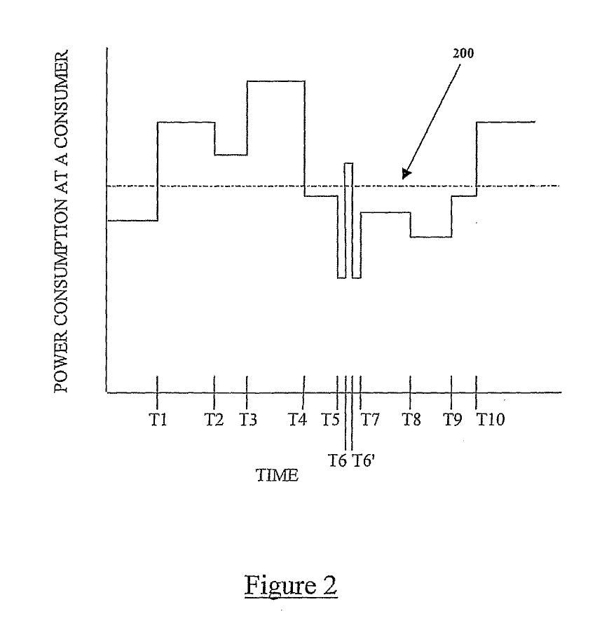

Referring now to the drawings, FIG. 1 is a block diagram of a preferred embodiment of a flexible electric load management system 10, according to the present invention. System 10 is adapted to be electrically connected between an incoming AC electric line from a power source, and a plurality of loads of the consumer. As used herein in the specification and in the claims section that follows, the term “power source” refers to an electricity-supplying utility (e.g., having a power grid) or generator for providing electrical power to at least one power consumer, or to a battery or other energy storage device for providing electrical power to the consumer.

Typically, system 10 is installed between a main circuit breaker 110 and at least one local circuit breaker typically present in any household or premises where system 10 is installed. Shown in FIG. 1, by way of example, are local circuit breakers 100: 100a, 100b, 100c, 100d, and 100e. Each local circuit breaker of circuit breakers 100 is connected to at least one electric load.

In FIG. 1, by way of example, circuit breaker 100a is electrically connected to loads L1, L2 and L3, circuit breaker 100b is electrically connected to load L4, circuit breaker 100c is electrically connected to load L5, circuit breaker 100d is electrically connected to load L6, and circuit breaker 100e is electrically connected to loads L7 and L8.

Loads L1-L8 represent electric loads on the premises of the consumer and may include household appliances, outlets for non-dedicated loads, lighting, heating and cooling devices, electric swimming pool apparatus, and any other load drawing electric power.

Electrically connected to each relay unit 90a-90e of relay units 90 is a current sensor 80a-80e of sensors 80 that continuously measures the current drawn by the loads connected to the associated local circuit breaker. In FIG. 1, by way of example, sensor 80a measures the total current drawn from loads L1, L2 and L3 through circuit breaker 100a.

According to one preferred embodiment of the present invention, a current sensor 130 measures the total current being drawn by all the loads on the premises. Current sensor 130 is adapted to connect electrically with the incoming AC electric line before the line branches to circuit breakers 100. Current sensor 130 is also electrically connected with a main central processing unit CPU 30. Current sensor 130 is necessary when not all circuit breakers 100 are monitored and controlled.

Sensors 80 send the measured data continuously or at short discrete intervals via at least one data line 70, typically an analog line, to a processing unit such as main CPU 30.

As used herein in the specification and in the claims section that follows, the term “main CPU” or “main central processing unit” is meant to refer to a central processing unit electrically disposed between the main circuit breaker of incoming power from a power supplier or utility, and the local circuit breakers that are electrically connected to the loads being monitored and controlled. Generally, a single CPU serves as main CPU 30.

When main CPU 30 determines that a reduction in power is necessary, main CPU 30 uses the data received from sensors 80, reviews the priorities in the system and transmits the relevant commands via communication or command line 75 to open and close relay units 90 in a specified order and for specified time lengths according to an algorithm pre-programmed into main CPU 30. The pre-programmed algorithm in main CPU 30 is described in greater detail hereinbelow.

Associated with main CPU 30 is a memory 60 that, inter alia, stores data on the currents drawn through circuit breakers 100 by the loads, the current positions and past behaviors of relay units 90, and the priorities and conditions of load management as determined by the consumer. Memory 60 may also store the history of the estimated power reduction achieved by system 10.

As used herein in the specification and in the claims section that follows, the term “lowest priority”, with respect to an electric line of a consumer, refers to an electric line that the consumer wishes to be disconnected first, upon a request for load reduction. As used herein in the specification and in the claims section that follows, the term “highest priority”, with respect to an electric line of a consumer, refers to an electric line that the consumer wishes to be disconnected last, upon a request for load reduction.

Also associated with and electrically connected to main CPU 30 is a receiver or transceiver 20 which is adapted to receive information from the electric utility (or more generally, from the power source), and preferably, to send information to the electric utility. Information received may include requests for load management. Information sent may include power reduced and power consumption data of interest to the utility. Transceiver 20 may receive and send signals through a wired or wireless modem, RF signaling or any alternative communications technology known to those skilled in the art.

Transceiver 20 may also be configured to receive priority information from the consumer. The input of the consumer is discussed in greater detail hereinbelow.

According to another preferred embodiment, a sensor 120 detects a drop in line frequency or other signals on the incoming AC electric line and transmits the signals, or data corresponding thereto, to main CPU 30. Sensor 120 is electrically adapted to an incoming AC electric line and connects electrically with main CPU 30.

Flexible load reduction typically begins when transceiver 20 receives a signal from the utility requesting load reduction of a specified or unspecified magnitude. The specified request may include an absolute amount, a percentage of current usage, a percentage of nominal capacity, or a percentage of average consumption. The pre-programmed algorithm in main CPU 30 closes and opens relay units 90 in order to achieve the requested load reduction, until transceiver 20 receives another signal signaling an end to the need for power reduction. At this time, main CPU 30 restores relay units 90 to their former, connected positions prior to the demand for load reduction.

Alternatively, load reduction in system 10 may be initiated by main CPU 30, when sensor 120 measures a frequency below a predetermined frequency threshold. Electric line frequency drops when there is peak electric usage and the electric network is strained. Alternatively, sensor 120 may detect any other predetermined signal from the utility on the incoming AC electric line that represents a need to reduce power usage. Load reduction continues until sensor 120 detects that the electric line frequency rises above the pre-determined threshold, or until sensor 120 detects the end of a power reduction need as per any other predetermined signal from the utility on the incoming AC electric line. After receiving this information from sensor 120, main CPU 30 restores relay units 90 to their former, connected positions prior to the demand for load reduction.

In the event of an emergency situation when there may not be time for flexible load management, transceiver 20 may receive a demand for immediate load shedding, until the electric network regains stability. System 10 may automatically close some or all relays. This action may help prevent the electric network from collapse and enable the utility company to fix the fault more rapidly.

The electric consumer enters his preferences to the pre-programmed algorithm in main CPU 30 using an input device 40, electrically connected to main CPU 30, and the consumer views his preferences by means of a display device 50 also connected to main CPU 30. The user decides which circuit breakers he is willing to turn off and under what conditions when there is a need to reduce power. Buildings are usually wired so that each circuit breaker is responsible for a certain area or for similar load types. Large electric loads which can be associated with appliances such as heaters, air-conditioning units, pool equipment, washers, dryers, and the like, are usually assigned their own circuit breaker. The user can change his priorities and conditions at any time.

According to one preferred embodiment of the present invention, when system 100 is electrically connected to all circuit lines branching from the main circuit breaker 110, a current sensor 130 measuring the total current being drawn by all the loads is not necessary as, a main CPU 30 can sum the total current from current readings of sensors 80.

As used herein in the specification and in the claims section that follows, the term “flexible load management”, with respect to a system such as system 100, refers to the main CPU being directly responsive to the priorities and preferences that are input by the electricity consumer or user.

With reference now to FIG. 2 as well, FIG. 2 is an exemplary graph of power consumption over time at a consumer showing the load management of the inventive system under varying electric loads. When flexible electric load management system 100 receives a command or indication to lower power consumption during peak demand hours, the system adjusts the loads so that the power consumption does not exceed a power threshold 200 for any significant length of time. Power threshold 200 may be defined in various ways, including an absolute power consumption, a percentage of current usage, a percentage of nominal capacity of the consumer, a percentage of average power consumption, or by another parameter or combination of parameters.

At time T1, at least one additional load begins drawing power from the power source, and the level of power consumption rises correspondingly. At time T2, power consumption drops slightly, while at time T3, there is an additional rise in power consumption. At time T4, system 100 receives a request to reduce power consumption on the premises to power threshold 200. Based on algorithms pre-programmed into main CPU 30 and based on the consumer's preferences and priorities previously input into main CPU 30, main CPU 30 decides which relay units need closing, and commands the relevant relay units accordingly. Subsequently, main CPU 30 commands the relay units in an effort to keep the power consumption from rising above power threshold 200.

Main CPU 30 constantly monitors the current in each electric line of sensors 80 and optionally, the total current drawn by the main electric line (measured by sensor 130), in order to adjust load consumption at any given time. At time T5, main CPU 30 detects a drop in total current on the premises, typically due to one or more loads being disconnected. As a result, main CPU 30 determines, according to the consumer's load preferences and priorities, which (one or more) of relay units 90 is to be opened. Next, CPU 30 calculates, based on a historical consumption (e.g., the consumption prior to the immediately previous disconnection, or a time-averaged consumption over a pre-determined period) via the appropriate electric lines, which line or lines can be reconnected to the power source without pushing the total power consumption above power threshold 200. At time T6, the appropriate relay unit, the lowest priority of the consumer (identified by main CPU 30) is opened, but the actual load is higher than expected, causing the total power consumption to rise above power threshold 200. Consequently, main CPU 30 closes the recently-opened relay, such that the power consumption returns (at time T6′) to a value below threshold 200. Main CPU 30 then determines whether it is possible to open the next-lowest priority relay. Also, system 100 will retry to open the closed relay having the lowest priority of the consumer, at a pre-defined time interval (e.g., 30 minutes), if the relay has not already been reopened. At time T7, the appropriate relay units are opened and the total power consumption remains under power threshold 200.

At time T8, main CPU 30 detects another fall in consumption, due to one or more loads being disconnected, such that at time T9, main CPU 30 is able to connect additional loads by opening another one or more relay units. CPU 30 decides to open the relay unit(s) based on the difference between At time T10, main CPU 30 receives a request to terminate load reduction, and subsequently opens all relay units 90 to their former positions before the initial load reduction request.

In the event that load reduction in system 10 is activated, the user may be reimbursed for the difference in power consumption before and after the load reduction is implemented. The direct relationship between power saved and monetary compensation has the advantage that the utility pays for the extra power capacity attained and does not pay program subscribers on a fixed-price basis, whether or not the utility has demanded a power reduction. In addition, the user who receives compensation that is proportional to the reduction he has achieved, may have incentive to try to save more.

Moreover, the consumer is more likely to be satisfied when he decides which loads to shed instead of the utility deciding on his behalf. Also, the consumer is more likely to continue participating in a program when he has the opportunity to alter settings according to his present needs.

The flexible load management system advantageously lowers power consumption at the consumer during peak loads for several reasons. The consumer decides on the parameters and priorities of the load reduction and he can change them with ease at any time. Moreover, the consumer enters the data by himself and is able to make changes according to his changing needs.

A further reason why the flexible load management system is advantageous, is that the pre-programmed algorithm monitors the currents continuously, and opens and closes relay units 90 accordingly, such that power is saved with minimum loss of comfort to the consumer. The continuous or frequent monitoring of current sensors 80 allow main CPU 30 to readjust the opening and closing of relay units 90 in real time, when there is a change in power consumption, so that the system succeeds in adhering to the priorities of the consumer as closely as possible.

Furthermore, the system is relatively simple and inexpensive, requiring solely a main CPU. The inventive flexible load management system has few electronic components and utilizes simple and robust communication methods. The various complicated and expensive inter-processor communications used in systems of the prior art are obviated by the inventive system.

As used herein in the specification and in the claims section that follows, the term “solely a main CPU” and the like, with respect to a load management system, is meant to indicate that in addition to the main CPU disposed between main circuit breaker 110 and local circuit breakers 100, there exist no local CPUs disposed between the local circuit breakers 100 and the loads.

As used herein in the specification and in the claims section that follows, the term “directly responsive to a main CPU”, and the like, with respect to a relay unit or relay assembly, refers to a relay unit or relay assembly that is directly commanded by the main CPU, without the help of additional CPUs disposed between the main CPU and the at least one load connected in series to the relay unit or relay assembly.

As used herein in the specification and in the claims section that follows, the term “power consumption” and the like, is meant to include the related parameters of energy consumption and current consumption. Similarly, the term “power consumption threshold” is meant to include a current consumption threshold or more typically, a threshold of current consumption per unit time.

The inventive flexible load management system is preferably disposed in a single location, and is not sprawled around the premises of the consumer. Consequently, the system is easily and inexpensively installed and maintained. Moreover, the system components are much less subject to damage than load-based system components that are attached to, or installed near, the various loads.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A computerized load management system for monitoring and controlling electricity consumption of an electricity consumer having a plurality of loads, the system comprising:
(a) a main central processing unit, connected to a power source, and adapted to receive a signal therefrom;
(b) a memory associated with said main central processing unit;
(c) a plurality of controlled relay assemblies connected to a plurality of loads via a plurality of local circuit breakers, each assembly of said assemblies including:
(i) a relay, responsive to said main central processing unit;
(ii) a current sensor, electrically connected to said relay, said relay and said current sensor being electrically associated with said main central processing unit, and
(iii) an electrical line having a first end connecting said relay assembly to said power source, and having a second end connecting to a local circuit breaker connected to at least one load;
wherein each said current sensor is adapted to provide, to said main central processing unit, data pertaining to current drawn via a particular local circuit breaker of said local circuit breakers,
and wherein said main central processing unit is configured to command said relay within each of said relay assemblies based on said signal received from said power source, and based on a set of rules provided to said main central processing unit, said set of rules including load priority information,
such that each said relay opens or closes in response to said command from said main central processing unit, so as to shut off power or restore power to a particular said electrical line.

2. The load management system of claim 1, wherein the computerized load management system is entirely disposed between a main circuit breaker connected to said power source, and said local circuit breakers.

3. The load management system of claim 1, wherein said main central processing unit, said memory and said relay assemblies are enclosed within a single housing.

4. The load management system of claim 2, wherein said main central processing unit, said memory and said relay assemblies are enclosed within a single housing.

5. The load management system of claim 1, wherein said main central processing unit is adapted to send, to said power source, information pertaining to power consumption.

6. The load management system of claim 5, wherein said information is based on said data provided by each said current sensor.

7. The load management system of claim 5, said information pertaining to power saved during load management.

8. The load management system of claim 1, wherein said main central processing unit is configured to display said load priority information for closing and opening said relay assemblies.

9. The load management system of claim 1, wherein said main central processing unit is configured to receive, from a user, input associated with priorities and conditions for closing and opening said relays.

10. The load management system of claim 1, further comprising:
(d) a current sensor, associated with said power source and said central processing unit, for measuring total current, as a function of time, being drawn by said loads, and for providing data pertaining to said current to said central processing unit.

11. The load management system of claim 1, wherein said main central processing unit is configured to command each said relay to close and open so that a total power consumption consumed by said plurality of loads is held beneath a power consumption threshold.

12. The load management system of claim 11, wherein said main central processing unit controls an order of opening and closing of said relays based on rules preprogrammed into said main central processing unit, said rules including:
(I) said main central processing unit closes at least a first relay of said relays, so as to cut off power to at least one of said loads, according to a lowest priority of the consumer.

13. The load management system of claim 12, wherein prior to (I), said main central processing unit determines, based on historical data on current drawn through said first relay, that said cut off of said power will reduce said total power consumption below said power consumption threshold.

14. The load management system of claim 12, said rules further including:
(II) said main central processing unit checks, in a substantially continuous manner, power consumption on each said electric line, and when a drop in said total power consumption is observed, said main central processing unit determines that at least one particular relay within said relay assemblies can be opened, without exceeding said power consumption threshold, and subsequently commands said particular relay to open, so as to restore power via said particular relay.

15. The load management system of claim 14, said rules further including:
(III) after at least one relay of said at least one particular relay is opened, said main central processing unit checks that said total power consumption is still beneath said power consumption threshold.

16. The load management system of claim 14, said rules further including:
(IV) if said main central processing unit determines that said total power consumption exceeds said threshold, said main central processing unit closes a lowest priority relay unit of said relay units.

17. The load management system of claim 16, said rules further including:
(V) after waiting for a predetermined time, said main central processing unit retries opening said lowest priority relay unit.

18. The load management system of claim 1, wherein disposed between said power source and said loads is solely said main central processing unit.

19. The load management system of claim 1, wherein said relay assemblies are directly responsive to said main central processing unit.

20. The load management system of claim 1, wherein at least one of said relay assemblies is connected to at least two appliances.

21. A computerized load management system for monitoring and controlling electricity consumption of an electricity consumer having a plurality of loads, the system comprising:
(a) a main central processing unit, adapted for connecting to a power source, and adapted to receive a signal therefrom;
(b) a memory associated with said main central processing unit;
(c) a plurality of controlled relay assemblies for connecting to a plurality of loads via a plurality of local circuit breakers, each assembly of said assemblies including:
(i) a relay, responsive to said main central processing unit;
(ii) a current sensor, electrically connected to said relay, said relay and said current sensor being electrically associated with said main central processing unit, and
(iii) an electrical line having a first end adapted for connecting said relay and said current sensor to said power source, and having a second end adapted for connecting to a local circuit breaker connected to at least one load,
wherein, when the load management system is connected to said power source and to said loads, each said current sensor is adapted to provide, to said main central processing unit, data pertaining to current drawn via a particular local circuit breaker of said local circuit breakers,
and wherein said main central processing unit is configured to command a relay of said relay assemblies based on said signal received from said power source, and based on a set of rules provided to said main central processing unit, said set of rules including load priority information, such that each said relay opens or closes in response to a command from said main central processing unit, so as to shut off power or restore power to a particular said electrical line,
and wherein said relay assemblies are directly responsive to said main central processing unit.

22. The load management system of claim 21, wherein at least one of said relay assemblies is adapted for at least two appliances.

23. A computerized load management system for monitoring and controlling electricity consumption of an electricity consumer having a plurality of loads, the system comprising:
(a) a main central processing unit, adapted for connecting to a power source, and adapted to receive a signal therefrom;
(b) a memory associated with said main central processing unit;
(c) a plurality of controlled relay assemblies for connecting to a plurality of loads via a plurality of local circuit breakers, each assembly of said assemblies including:
(i) a relay, responsive to said main central processing unit;
(ii) a current sensor, electrically connected to said relay, said relay and said current sensor being electrically associated with said main central processing unit, and
(iii) an electrical line having a first end adapted for connecting said relay and said current sensor to said power source, and having a second end adapted for connecting to a local circuit breaker connected to at least one load,
wherein, when the load management system is connected to said power source and to said loads, each said current sensor is adapted to provide, to said main central processing unit, data pertaining to current drawn via a particular local circuit breaker of said local circuit breakers,
and wherein said main central processing unit is configured to command a relay of said relay assemblies based on said signal received from said power source, and based on a set of rules provided to said main central processing unit, said set of rules including load priority information, provided by the electricity consumer, such that each said relay opens or closes in response to a command from said main central processing unit, so as to shut off power or restore power to a particular said electrical line.

24. The load management system of claim 23, wherein the computerized load management system is entirely disposed between a main circuit breaker connected to said power source, and said local circuit breakers.

25. The load management system of claim 23, wherein the said main central processing unit, said memory and said relay assemblies are enclosed within a single housing.
